(19) United States
(12) Patent Application Publication
(10) Pub. No.: US 2026/0221887 A1
(43) Pub. Date: Jul. 30, 2026

(54) POWER SUPPLY DEVICE

(71) Applicant: TOYOTA JIDOSHA KABUSHIKI KAISHA, Toyota-shi (JP)

(72) Inventors: Yuki KAWASAKI, Toyota-shi (JP); Soichiro ITO, Toyota-shi (JP)

(73) Assignee: TOYOTA JIDOSHA KABUSHIKI KAISHA, Toyota-shi (JP)

(21) Appl. No.: 19/428,824

(22) Filed: Dec. 22, 2025

(30) Foreign Application Priority Data
Jan. 24, 2025 (JP) 2025-010734

(51) Int. Cl. H02M 3/335; B60L 15/00; H02M 1/32

(52) U.S. Cl. CPC H02M 3/33573; B60L 15/007; H02M 1/327; H02M 3/33584; B60L 2210/10; B60L 2210/42

(57) ABSTRACT

A power supply device includes a power supply, a first inverter, a second inverter, a first relay, a second relay, a capacitor, a third relay, a resistor, a bidirectional DC/DC converter, and a control unit.

### CROSS-REFERENCE TO RELATED APPLICATION

This application is based upon and claims the benefit of priority of the prior Japanese Patent Application No. 2025-010734, filed on Jan. 24, 2025, the entire contents of which are incorporated herein by reference.

### TECHNICAL FIELD

The present disclosure relates to a power supply device.

### BACKGROUND

In relation to a power supply device, for example, Japanese Patent Application Publication No. 2020-96520 discloses two inverters connected to each other via a winding of each phase of a motor mounted on a vehicle. The two inverters and the power supply of the motor are connected by a pair of power lines. A pair of relays (SMR: System Main Relay) is interposed in each power line. A smoothing capacitor is connected between the pair of power lines on the input side of each inverter.

For example, when the power supply device is activated, an inrush current flows from the power supply of the motor toward the inverter. In order to cope with this, the power supply device charges (precharges) the smoothing capacitor via the resistor for inrush current prevention and the other relay, before the power supply and the inverter are connected via the pair of relays. This relay is hereinafter referred to as a “precharging relay”. By precharging the smoothing capacitor, a difference in voltage between the power supply and the inverter is reduced as compared with the difference before the precharging, and thus the inrush current at the time of activation of the power supply device is suppressed.

In a case where the power supply device is activated in cooperation with an external device (for example, a charger), when the power supply device is repeatedly reactivated due to deterioration of a communication environment with the external device, the resistor might be overheated due to the precharging relay being opened and closed at a high frequency. At this time, when the closing of the precharging relay is restricted according to, for example, the temperature of the resistor, the precharge is impossible until the precharging relay is sufficiently cooled, and thus the activation of the power supply device might be delayed.

### SUMMARY

It is therefore an object of the present disclosure to provide a power supply device capable of being quickly activated.

The above object is achieved by a power supply device including: a power supply that supplies power to a motor that drives a vehicle; a first inverter and a second inverter connected to each other via a winding of each phase of the motor; a first relay and a second relay respectively interposed in a pair of power lines between both terminals of the power supply and the first inverter and the second inverter; a capacitor configured to smooth a voltage between the pair of power lines on an input side of the first inverter or the second inverter; a third relay including an end connected between the second relay and the first inverter; a resistor including: an end connected to another end of the third relay; and another end connected between one of the both terminals of the power supply and the second relay; a bidirectional DC/DC converter including: a pair of first input/output terminals connected to the pair of power lines; and a pair of second input/output terminals connected to both terminals of an auxiliary battery of the vehicle; and a control unit configured to control the first relay, the second relay, the third relay, and the bidirectional DC/DC converter, wherein the control unit is configured to switch a mode of the control unit to a first mode or a second mode in accordance with a temperature of the resistor, closing of the third relay being unrestricted in the first mode and being restricted in the second mode, the control unit in the first mode is configured to control the first relay and the third relay to be closed to charge the capacitor from the power supply, when the first relay, the second relay, and the third relay are in an open state, and to control the second relay and the third relay to be closed and opened respectively after charging of the capacitor is finished, the control unit in the second mode is configured to control the first relay to be closed and to control the bidirectional DC/DC converter so as to charge the capacitor from the auxiliary battery, when the first relay, the second relay, and the third relay are in an open state, and to control the second relay to be closed after the charging of the capacitor is finished.

In the power supply device described above, the control unit may be configured to estimate the temperature of the resistor based on a number of times the third relay is controlled to be closed, and the control unit may be configured to switch the mode to the first mode when the temperature is less than a threshold value, and to switch the mode to the second mode when the temperature is equal to or greater than the threshold value.

In the power supply device described above, the control unit may be configured to lower the temperature by a predetermined value every time a certain period of time elapses.

### BRIEF DESCRIPTION OF THE DRAWINGS

FIG. 1 is a configuration view illustrating a power supply device;

FIG. 2A is a configuration view illustrating an electronic control unit (ECU), and FIG. 2B is a circuit diagram illustrating a bidirectional DC/DC converter;

FIG. 3A is a view illustrating precharging operation of a smoothing capacitor on an input side of an inverter in a normal mode, and FIG. 3B is a view illustrating precharging operation of the smoothing capacitor on the input side of the inverter in the restricted mode;

FIG. 4A is a view illustrating precharging operation of a smoothing capacitor on an input side of the other inverter in the normal mode, and FIG. 4B is a view illustrating precharging operation of the smoothing capacitor on the input side of the other St inverter in the restricted mode;

FIG. 5 is a flowchart illustrating a process of switching between the normal mode and the restricted mode; and

FIG. 6 is a flowchart illustrating a precharging process.

### DETAILED DESCRIPTION

### Configuration of Power Supply Device

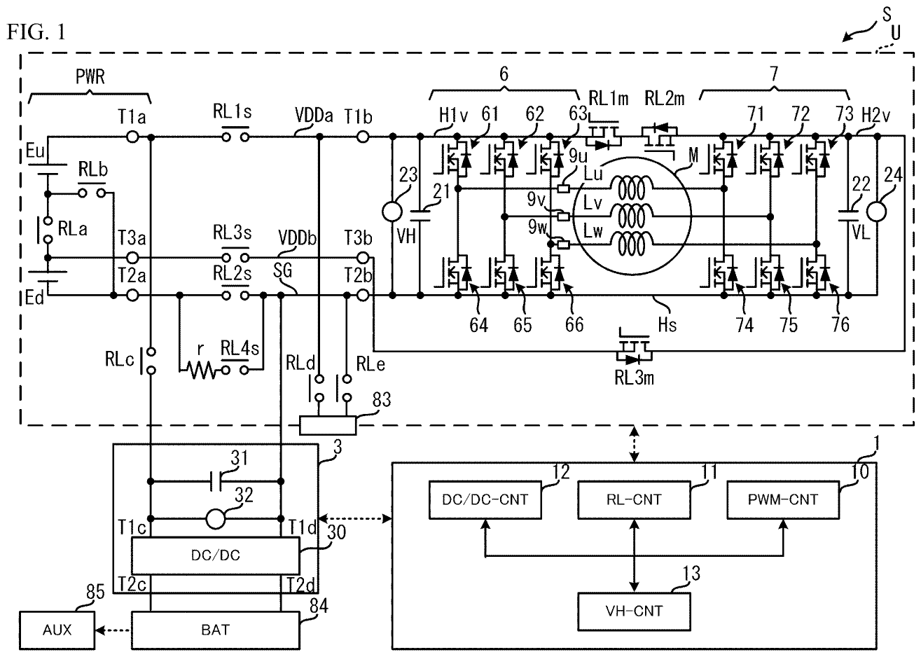

FIG. 1 is a configuration view illustrating a power supply device S. The power supply device S is mounted on a vehicle such as an electric vehicle or a hybrid vehicle. The power supply device S includes a drive unit U, a control unit 1, and a charging unit 3.

The drive unit U includes a power source PWR, a motor M, inverters 6 and 7, current sensors 9u to 9w, smoothing capacitors 21 and 22, voltage sensors 23 and 24, relays RL1s to RL4s, RLc to RLe, and RL1m to RL3m, a resistor r, and an inlet 83. The power supply PWR is connected to the inverters 6 and 7 via power supply lines VDDa and VDDb and a ground line SG. The motor M is connected between the inverters 6 and 7. The power supply lines VDDa and VDDb and the ground line SG are examples of a pair of power lines.

The motor M drives the vehicle. The motor M includes a rotor and a stator (not illustrated). The stator has windings Lu, Lv, and Lw of a u phase, a v phase, and a w phase. The stator generates a rotating magnetic field by three phase alternating current flowing through the windings Lu, Lv, and Lw. The rotor has, for example, a permanent magnet and rotates in accordance with a rotating magnetic field of the stator.

The current sensors 9u, 9v, and 9w are connected in series with the windings Lu, Lv, and Lw, respectively. The current sensors 9u, 9v, and 9w detect the current values of the u phase, the v phase, and the w phase, respectively. Each of the current sensors 9u, 9v, and 9w outputs the current value to the control unit 1.

The power supply PWR supplies power to the motor M via the power supply lines VDDa and VDDb and the ground line SG. The power source PWR includes batteries Eu and Ed, relays RLa and RLb, and terminals T1a to T3a. The batteries Eu and Ed are, for example, lithium ion batteries. The batteries Eu and Ed are connected in series with each other via a relay RLa. The negative electrode of the battery Eu is connected to an end of the relay RLa. The positive electrode of the battery Ed is connected to the other end of the relay RLa.

The power source PWR is connected to the inverters 6 and 7 via the terminals T1a to T3a. The terminals T1a and T3a are connected to the power lines VDDa and VDDb, respectively. The terminal T2a is connected to the ground line SG. The terminal T1a is led out from the positive electrode of the battery Eu. The terminal T2a is led out from the negative electrode of the battery Ed. The terminal T3a is led out from the contacts between the end of the relay RLa and the positive electrode of the battery Ed.

An end of the relay RLb is connected to a wire between the end of the relay RLa and the negative electrode of the battery Eu. The other end of the relay RLb is connected to a wire between the negative electrode of the battery Ed and the terminal T2a. When the relay RLa is closed and the relay RLb is open, the batteries Eu and Ed are connected in series with each other. When the relay RLa is in an open state and the relay RLb is in a closed state, the batteries Eu and Ed are connected in parallel to each other.

The inverters 6 and 7 are connected to each other via windings Lu, Lv, and Lw. The inverters 6 and 7 convert a DC current of the power supply PWR into a three phase AC current and output the three phase AC current to the motor M. The inverters 6 and 7 are examples of first and second inverters.

The inverter 6 includes switching elements 61 to 66. The switching elements 61 to 66 are connected between a high-potential-side wire H1v and a low-potential-side wire Hs. The inverter 7 includes switching elements 71 to 76. The switching elements 71 to 76 are connected between a high-potential-side wire H2v and the low-potential-side wire Hs. The high-potential-side wire H1v and the low-potential-side wire Hs are power supply lines in the invertor 6, and the high-potential-side wire H2v and the low-potential-side wire Hs are power supply lines in the invertor 7. Each of the potentials of the high-potential-side lines H1v and H2v is higher than the potential of the low-potential-side line Hs.

The inverters 6 and 7 have input terminals T1b to T3b. The output terminal T1b is led out from the high-potential-side wire H1v of the invertor 6 and connected to the power source line VDDa. The input terminal T2b is led out from the low potential-side wiring Hs of the inverters 6 and 7 and connected to the ground line SG. The input terminal T3b is led out from the high-potential-side wire H2v of the invertor 7 and connected to the power source line VDDb.

Each of the switching elements 61 to 66 and 71 to 76 has a freewheeling diode connected between two input/output terminals. The switching elements 61 to 66 and 71 to 76 are, for example, insulated gate bipolar transistors (IGBTs) or metal-oxide-semiconductor field-effect-transistors (MOSFETs), but may be other electronic components.

In the inverter 6, one of input/output terminals of each of the switching elements 61 to 63 on the upper arm side is connected to the high potential-side wire H1v, and one of input/output terminals of each of the switching elements 64 to 66 on the lower arm side is connected to the low potential-side wire Hs. The switching elements 61 to 63 on the upper arm side and the switching elements 64 to 66 on the lower arm side are connected in series to each other, respectively. The contact points between the switching elements 61 to 63 on the upper arm side and the switching elements 64 to 66 on the lower arm side are connected to ends of the windings Lu, Lv, and Lw, respectively.

In the invertor 7, one of input/output terminals of each of the switching elements 71 to 73 on the upper arm side is connected to the high-potential-side wire H2v, and one of input/output terminals of each of the switching elements 74 to 76 on the lower arm side is connected to the low-potential-side wire Hs. The switching elements 71 to 73 on the upper arm side and the switching elements 74 to 76 on the lower arm side are connected in series to each other. The contact points between the switching elements 71 to 73 on the upper arm side and the switching elements 74 to 76 on the lower arm side are connected to the other ends of the windings Lu, Lv, and Lw, respectively. Further, the control terminals of the switching elements 61 to 66 and 71 to 76 are connected to the control unit 1.

A contact point of the switching elements 61 and 64 and a contact point of the switching elements 71 and 74 are connected to the winding Lu of the u phase. A contact point of the switching elements 62 and 65 and a contact point of the switching elements 72 and 75 are connected to the winding Lv of the v phase. A contact point of the switching elements 63 and 66 and a contact point of the switching elements 73 and 76 are connected to the winding Lw of the w phase.

The smoothing capacitor 21 is connected between the high-potential-side wire H1v and the low-potential-side wire Hs on the input-side of the invertor 6. The smoothing capacitor 21 smooths a voltage between the power supply line VDDa and the ground line SG on the input side of the inverter 6. The voltage sensor 23 is connected in parallel to the smoothing capacitor 21. The voltage sensor 23 detects a voltage VH between both terminals of the smoothing capacitor 21. The voltage sensor 23 outputs a detection value to the control unit 1.

The smoothing capacitor 22 is connected between the high-potential-side wire H2v and the low-potential-side wire Hs on the input side of the invertor 7. The smoothing capacitor 22 smooths a voltage between the power supply line VDDb and the ground line SG on the input side of the inverter 7. The voltage sensor 24 is connected in parallel to the smoothing capacitor 22. The voltage sensor 24 detects a voltage VL between both terminals of the smoothing capacitor 22. The voltage sensor 24 outputs a detection value to the control unit 1. The smoothing capacitors 21 and 22 are examples of capacitors.

The relays RL1m and RL2m are connected between the high-potential-side wire H1v and the high-potential-side wire H2v. The relays RL1m and RL2m are connected in series with each other. The relay RL3m is interposed in the high-potential-side wire H2v between the input terminal T3b and the voltage sensor 24. When the electric power of the batteries Eu and Ed is supplied to the motor M, the relays RL1m and RL2m are closed, and the relay RL3m is opened. When only the power of the battery Ed is supplied to the motor M, the relay RL1m and the relay RL2m are in the open state, and the relay RL3m is in the closed state.

The relays RL1s to RL4s and the resistor r are connected between the power source PWR and the inverters 6 and 7. The connection form between the power source PWR and the inverters 6 and 7 is switched depending on the open/closed state of the relays RL1s to RL4s.

The relays RL1s and RL3s are examples of a first relay, and the relay RL2s is an example of a second relay. The relay RL1s is interposed in the power line VDDa between the terminals T1a of the power source PWR and the input terminal T1b of the inverters 6 and 7. The relay RL2s is interposed in the ground line SG between the terminal T2a of the power source PWR and the input terminals T2b of the inverters 6 and 7. The relay RL3s is interposed in the power line VDDb between the terminal T3a of the power source PWR and the input terminal T3b of the inverters 6 and 7.

The relay RL4s is an example of a third relay. The relay RL4s is connected in series with the resistor r. Both ends of the series circuit of the relay RL4s and the resistor r are connected to both ends of the relay RL2s. An end of the relay RL4s is connected between the relay RL2s and the input terminal T2b of the inverters 6 and 7. The other end of the relay RL4s is connected to one end of the resistor r. The other end of the resistor r is connected between the terminal T2a of the power source PWR and the relay RL2s.

In the power supply PWR, when the relay RLa is in an open state and the relay RLb is in a closed state, the batteries Eu and Ed are connected in parallel to each other. At this time, for example, a DC charger (not illustrated) charges the batteries Eu and Ed via the inlet 83. The inlet 83 is connected to the power line VDDa between the relay RL1s and the input terminal T1b of the invertor 7 via the relay RLd. The inlet 83 is connected to the ground line SG between the relay RL2s and the input terminal T2b of the inverter 7 via the relay RLe. When the batteries Eu and Ed are charged via the inlet 83, the relays RLd and RLe are closed.

In the power supply PWR, when the relay RLa is in a closed state and the relay RLb is in an open state, the batteries Eu and Ed are connected in series to each other. In this case, when the relays RL1s and RL2s and the relays RL1m and RL2m are closed and the relays RL3s and RL4s are opened, the electric power of the batteries Eu and Ed is supplied from the input terminals T1b and T2b to the motor M via the inverters 6 and 7. At this time, each of the switching elements 61 to 66 of the inverter 6 performs a switching operation in accordance with a PWM (Pulse Width Modulation) signal input to a control terminal thereof. The switching elements 71 to 73 of the inverter 7 are turned on, and the switching elements 74 to 75 are turned off.

In the power source PWR, when the relays RLa and RLb are in the open state, the relays RL2s, RL3s and the relays RL1m to RL3m are closed, and when the relays RL1s and RL4s are opened, only the battery Ed is connected to the inverters 6 and 7. The electric power of the battery Ed is supplied to the motor M from the input terminals T3b and T2b via the invertor 7. At this time, each of the switching elements 71 to 76 of the inverter 7 performs a switching operation in accordance with the PWM signal input to the control terminal thereof. Further, the switching elements 61 to 63 of the inverter 6 are turned on, and the switching elements 64 to 65 are turned off.

In any of the above cases, the control unit 1 charges (precharges) the smoothing capacitors 21 and 22 from the power source PWR via the resistor r and the relays RL4s in order to suppress welding of the relays RL1s to RL3s due to an inrush current from the power source PWR at the time of activation. By precharging the smoothing capacitor, the difference in voltage between the power supply PWR and the inverters 6 and 7 is reduced as compared with the difference before the precharging, and thus the inrush current at the time of activation of the power supply device S is suppressed.

The relay RL4s is a precharging relay. In a case where the relay RL2s is closed, the relay RL4s is closed when the smoothing capacitors 21 and 22 are precharged from the power source PWR. At this time, the rush current is reduced by flowing through the resistor r, and therefore, the welding of the relay RL4s due to the rush current is suppressed.

In the case where the power supply device S is activated in cooperation with an external device (e.g., a charging device), when the power supply device S is repeatedly reactivated due to deterioration of communication environments with the external device, the relay RL4s is opened and closed at a high frequency, and thus the resistor r might be overheated. When the closing of the relay RL4s is restricted according to the temperature of the resistor r, the precharging is impossible until the precharging relay is sufficiently cooled, and thus, there is a concern that the activation of the power supply device S might be delayed.

Therefore, when there is a possibility that the resistor r is overheated at the time of activating the power supply device S, the control unit 1 does not control the relay RL4s to be closed, and controls a bidirectional DC/DC converter 30 in the charging unit 3 to precharge the smoothing capacitors 21 and 22 from the auxiliary battery 84. The details of the precharging of the smoothing capacitors 21 and 22 will be described later.

The charging unit 3 charges an auxiliary battery (BAT) 84 with the power supply PWR. The auxiliary battery 84 supplies electric power to an auxiliary device (AUX) 85 of the vehicle. The auxiliary device 85 is, for example, a monitoring camera of the vehicle, an air conditioner, or the like.

The charging unit 3 includes the bidirectional DC/DC converter 30, a capacitor 31, and a voltage sensor 32. The charging unit 3 is, for example, a 2-in-1 unit. The 2in1 unit includes an on-board charger (OBC) (not illustrated) and the like in addition to the above-described configuration. The OBC includes, for example, a dual active bridge (DAB). The OBC charges the batteries Eu and Ed by an AC charger (not illustrated).

The bidirectional DC/DC converter 30 includes a pair of input/output terminals T1c and T1d on the primary side and a pair of input/output terminals T2c and T2d on the secondary side. The input/output terminals T1c and T1d are connected to the terminals T1a and T2a of the power source PWR, respectively. The input/output terminal T1c is connected to the power line VDDa between the terminal T1a of the power source PWR and the relay RL1s. The input/output terminal T1d is connected to the ground line SG between the relay RL2s and the input terminal T2b of the inverters 6 and 7. The relay RLc is connected between the input/output pin T1c and the pin T1a of the power source PWR. The relay RLc is closed when the auxiliary battery 84 is charged. The input/output terminals T1c and T1d are an example of a pair of first input/output terminals.

The input/output terminals T2c and T2d are connected to the positive and negative terminals of the auxiliary battery 84, respectively. The input/output terminals T2c and T2d are an example of a pair of second input/output terminals.

The capacitor 31 is connected between the input/output terminals T1c and T1d. The capacitor 31 smooths a voltage between the input/output terminals T1c and T1d. The voltage sensor 32 is connected in parallel with the capacitor 31. The voltage sensor 32 detects a voltage between both ends of the capacitor 31.

The control unit 1 controls the drive unit U and the charging unit 3. The control unit 1 includes a PWM control unit (PWM-CNT) 10, a relay control unit (RL-CNT) 11, a converter control unit (DC/DC-CNT) 12, and a vehicle control unit (VH-CNT) 13. The control unit 1 is an example of a control unit.

The PWM control unit 10 controls the switching operation of the inverters 6 and 7 by outputting PWM signals to the inverters 6 and 7. The PWM control unit 10 controls the duty ratio of the PWM signal based on the detection values of the current sensors 9u to 9w and the voltage sensors 23 and 24, for example, according to a required value of the torque of the motor M.

The relay control unit 11 controls opening and closing of the relays RLa to RLe, RL1s to RL4s, and RL1m to RL3m. The converter control unit 12 controls the switching operation of the bidirectional DC/DC converter 30 by outputting a PWM signal to the bidirectional DC/DC converter 30. The vehicle control unit 13 outputs instructions to the PWM control unit 10, the relay control unit 11, and the converter control unit 12 so as to cooperate with each other according to the operation state of the vehicle. The PWM control unit 10, the relay control unit 11, the converter control unit 12, and the vehicle control unit 13 are each implemented by, for example, an ECU.

### Configuration of ECU

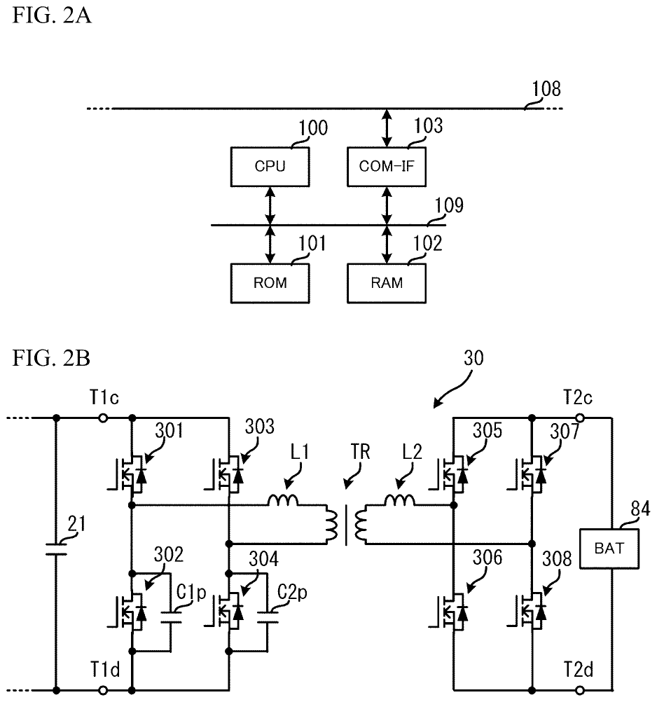

FIG. 2A is a configuration view illustrating the ECU. The ECU is an example of a computer. The ECU includes a central processing unit (CPU) 100, a read only memory (ROM) 101, a random access memory (RAM) 102, a communication interface (COM-IF) 103, and the like. The CPU 100 operates according to a program stored in the ROM 101. The CPU 100 is electrically connected to the ROM 101, RAM 102, and COM-IF 103 via a bus 109.

The ROM 101 stores a program for driving the CPU 100. The RAM 102 functions as a working memory of the CPU 100. The COM-IF 103 processes communication between the CPU 100 and another ECU connected via a global bus 108.

The PWM control unit 10, the relay control unit 11, the converter control unit 12, and the vehicle control unit 13 are each implemented by an ECU. The ECUs are connected to each other via the global bus 108. However, the PWM control unit 10, the relay control unit 11, the converter control unit 12, and the vehicle control unit 13 may be implemented by, for example, one or more integrated circuit (IC) chips.

### Configuration of Bidirectional DC/DC Converter

FIG. 2B is a circuit diagram illustrating the bidirectional DC/DC converter 30. The primary side circuit of the bidirectional DC/DC converter 30 includes switching elements 301 to 304, an inductor L1, and bypass capacitors C1p and C2p. The secondary side circuit of the bidirectional DC/DC converter 30 includes switching elements 305 to 308 and an inductor L2. The switching elements 301 to 308 are, for example, IGBTs or MOSFETs, but may be other electronic components. The input/output terminals of the switching elements 301, 303, 305, and 307 on the upper arm side are connected to the input/output terminals of the switching elements 302, 304, 306, and 308, respectively.

The primary circuit and the secondary circuit of the bidirectional DC/DC converter 30 are connected to each other via a transformer TR. The connection points between the switching elements 301, 303, 305, and 307 on the upper arm side and the switching elements 302, 304, 306, and 308 on the lower arm side are connected to the transformer TR. An inductor L1 is connected between the connection point of the switching elements 301 and 302 and the transformer TR. An inductor L2 is connected between the connection point of the switching elements 305 and 306 and the transformer TR.

The other input/output terminals of the switching elements 301 and 303 are connected to an input/output terminal T1c of the bidirectional DC/DC converter 30. The other input/output terminals of the switching elements 302 and 304 are connected to an input/output terminal T1d of the bidirectional DC/DC converter 30. The bypass capacitors C1p and C2p are connected between the input/output terminals of the switching device 302 and 304. The other input/output terminals of the switching elements 305 and 307 are connected to the input/output terminal T2c of the bidirectional DC/DC converter 30. The other input/output terminals of the switching elements 306 and 308 are connected to an input/output terminal T2d of the bidirectional DC/DC converter 30.

Control terminals of the switching elements 301 to 308 are connected to the converter control unit 12. The converter control unit 12 outputs a PWM signal to the control terminals of the switching elements 301 to 308. As a result, the switching elements 301 to 308 perform switching operations, and thus voltage conversion is performed between the primary side circuit and the secondary side circuit of the bidirectional DC/DC converter 30. At this time, the smoothing capacitor 21 is precharged to smooth the voltage between the input/output terminals T1c and T1d.

The bidirectional DC/DC converter 30 charges the auxiliary battery 84 from the power supply PWR while the motor M is stopped. Thus, the auxiliary device 85 can operate even when the vehicle is parked.

### Precharging Operation

The vehicle control unit 13 switches a mode to one of a normal mode and a restricted mode according to the temperature of the resistor r when the precharging is executed. The closing of the relay RL4s is unrestricted in the normal mode, but is restricted in the restricted mode. The normal mode is an example of a first mode, and the restricted mode is an example of a second mode. The following is an example of precharging operation of the smoothing capacitors 21 and 22 in the normal mode and the restricted mode.

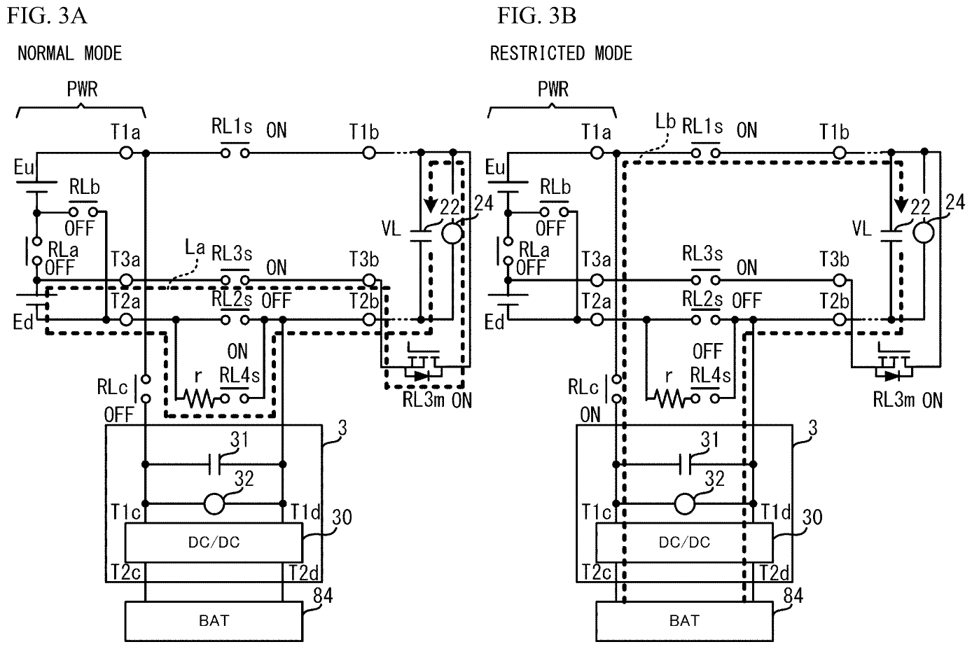

FIG. 3A is a view illustrating the precharging operation of the smoothing capacitor 22 on the input side of the inverter 7 in the normal mode. In FIG. 3A, the same reference numerals as those in FIG. 1 denote the same parts as those in FIG. 1. In FIG. 3A, the description of the same components as those in FIG. 1 is omitted here. Before the precharging operation, the relays RLa to RLe, RL1s to RL4s, RLc to RLe, and RL1m to RL3m are in an open state.

In the normal mode, the vehicle control unit 13 charges the smoothing capacitor 22 only from the battery Ed. In the normal mode, the relay control unit 11 controls the relay RL4s to be closed. Since the relay RLc is in the open state, the charging unit 3 is not energized by the power supply PWR.

In the normal mode, the relay control unit 11 controls the relays RL1s, RL3s, RL4s, and RL3m to be closed in accordance with an instruction from the vehicle control unit 13. Therefore, the battery Ed is connected in parallel with the smoothing capacitor 22. Therefore, the smoothing capacitor 22 is charged from the power supply PWR along the path La. The vehicle control unit 13 finishes the charging when, for example, the voltage detected by the voltage sensor 24 becomes substantially equal to the voltage of the battery Ed.

After the charging of the smoothing capacitor 22 is finished, the relay control unit 11 controls the relay RL2s to be closed and controls the relay RL4s to be opened in accordance with an instruction from the vehicle control unit 13. As a result, a current flows in the power supply lines VDDa and VDDb and the ground line SG between the power supply PWR and the inverters 6 and 7, and the power supply device S is activated.

FIG. 3B is a view illustrating the precharging operation of the smoothing capacitor 22 on the input side of the inverter 7 in the restricted mode. In FIG. 3B, the same reference numerals as those in FIG. 1 denote the same parts as those in FIG. 1. In FIG. 3B, the description of the same components as those in FIG. 1 is omitted. Before the precharging operation, the relays RLa to RLe, RL1s to RL4s, RLc to RLe, and RL1m to RL3m are in an open state.

In the restricted mode, the vehicle control unit 13 restricts the closing control of the relay RL4s to the relay control unit 11. Therefore, the relay control unit 11 does not control the relay RL4s to be closed. This prevents the resistor r from being overheated.

In the restricted mode, the relay control unit 11 controls the relays RL1s, RLc, RL1m, and RL2m to be closed in accordance with an instruction from the vehicle control unit 13. Therefore, the smoothing capacitor 22 is connected between the input/output terminals T1c and T1d of the bidirectional DC/DC converter 30. Thereafter, the vehicle control unit 13 controls the bidirectional DC/DC converter 30 by the converter control unit 12, thereby charging the smoothing capacitor 22 from the auxiliary battery 84 along the path Lb. The vehicle control unit 13 finishes the charging when, for example, the voltage detected by the voltage sensor 24 becomes substantially equal to the voltage of the battery Ed.

The relay control unit 11 controls the second relay RL2s to be closed after the charging of the smoothing capacitor 22 is finished. As a result, a current flows in the power supply lines VDDa and VDDb and the ground line SG between the power supply PWR and the inverters 6 and 7, and the power supply device S is activated.

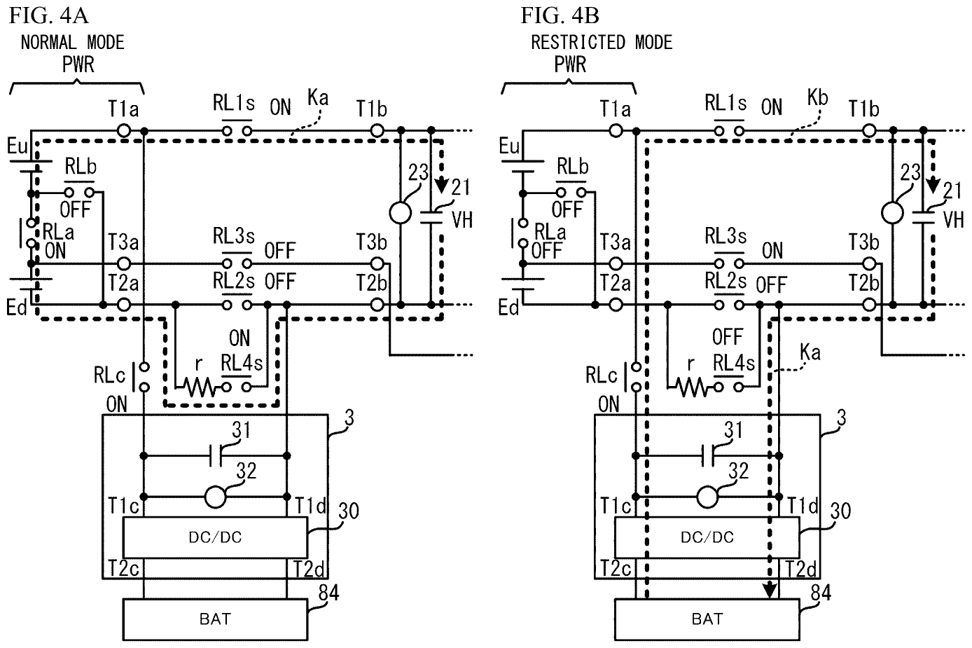

FIG. 4A is a view illustrating the precharging operation of the smoothing capacitor 21 on the input side of the inverter 6 in the normal mode. In FIG. 4A, the same reference numerals as those in FIG. 1 denote the same parts as those in FIG. 1. In FIG. 4A, the description of the same components as those in FIG. 1 is omitted here. Before the precharging operation, the relays RLa to RLe, RL1s to RL4s, RLc to RLe, and RL1m to RL3m are in an open state.

The vehicle control unit 13 charges the smoothing capacitor 21 from the batteries Eu and Ed in the normal mode. In the normal mode, the relay control unit 11 controls the relay RL4s to be closed. Since the relay RLc is in the open state, the charging unit 3 is not energized by the power supply PWR.

In the normal mode, the relay control unit 11 controls the relays RLa, RL1s, and RL4s to be closed in accordance with an instruction from the vehicle control unit 13. Therefore, the batteries Eu and Ed and the smoothing capacitor 21 are connected in parallel with each other. Therefore, the smoothing capacitor 21 is charged from the power supply PWR along the path Ka. The vehicle control unit 13 finishes the charging when, for example, the voltage detected by the voltage sensor 23 becomes substantially equal to the total voltage of the batteries Eu and Ed.

After the charging of the smoothing capacitor 21 is finished, the relay control unit 11 controls the relay RL2s to be closed and the relay RL4s to be opened in accordance with the instruction of the vehicle control unit 13. As a result, a current flows in the power supply line VDDa and the ground line SG between the power supply PWR and the inverters 6 and 7, and the power supply device S is activated.

FIG. 4B is a view illustrating the precharging operation of the smoothing capacitor 21 on the input side of the inverter 6 in the restricted mode. In FIG. 4B, the same reference numerals as those in FIG. 1 denote the same parts as those in FIG. 1. In FIG. 4B, the description of the same components as those in FIG. 1 is omitted here. Before the precharging operation, the relays RLa to RLe, RL1s to RL4s, RLc to RLe, and RL1m to RL3m are in an open state.

In the restricted mode, the relay control unit 11 controls the relays RL1s, RLc, and RL3s to be closed in accordance with an instruction from the vehicle control unit 13. Therefore, the smoothing capacitor 21 is connected between the input/output terminals T1c and T1d of the bidirectional DC/DC converter 30. Thereafter, the vehicle control unit 13 controls the bidirectional DC/DC converter 30 by the converter control unit 12 to charge the smoothing capacitor 21 from the auxiliary battery 84 along the path Kb. The vehicle control unit 13 finishes the charging when, for example, the voltage detected by the voltage sensor 23 becomes substantially equal to the total voltage of the batteries Eu and Ed.

The relay control unit 11 controls the second relay RL2s to be closed after the charging of the smoothing capacitor 22 is finished. As a result, a current flows in the power supply lines VDDa and VDDb and the ground line SG between the power supply PWR and the inverters 6 and 7, and the power supply device S is activated.

As described above, the control unit 1 precharges the smoothing capacitors 21 and 22 from the power supply PWR in the normal mode, and precharges the smoothing capacitors 21 and 22 from the auxiliary battery 84 by controlling the bidirectional DC/DC converter 30 in the restricted mode. Therefore, the power supply device S can be quickly activated in the restricted mode without waiting for the resistor r to cool.

### Temperature Estimation of Resistor

The vehicle control unit 13 estimates the temperature of the resistor r based on, for example, the number of times the relay RL4s is controlled to be closed. The vehicle control unit 13 switches to the normal mode when the temperature of the resistor r is less than the threshold value, and switches to the restricted mode when the temperature of the resistor r is equal to or greater than the threshold value.

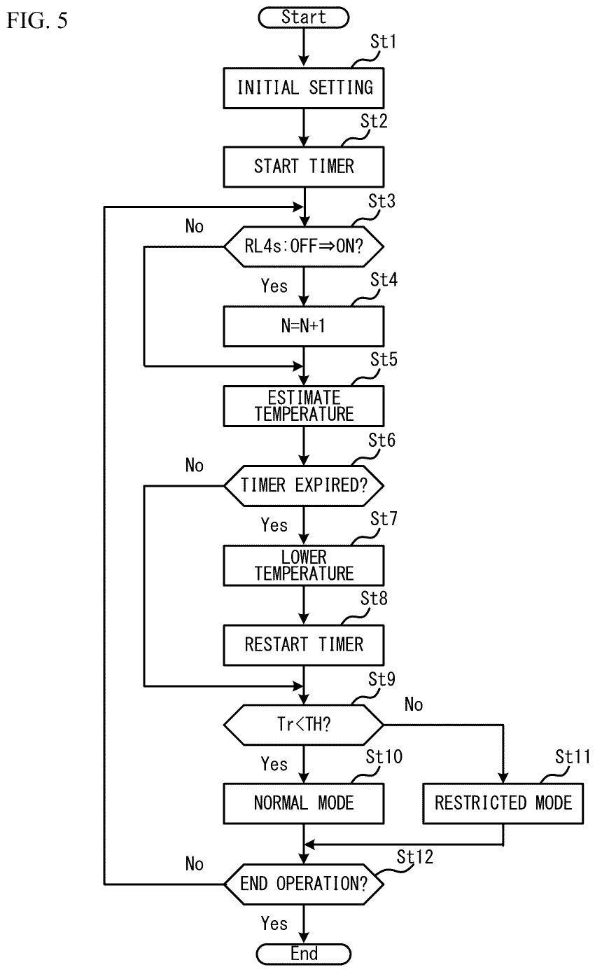

FIG. 5 is a flowchart illustrating a process of switching between the normal mode and the restricted mode. This process is executed, for example, after the power supply of the control unit 1 is turned on.

First, the vehicle control unit 13 executes initial setting (St1). At this time, the vehicle control unit 13 sets the number of times N that the relay RL4s is controlled to be closed to zero. The vehicle control unit 13 sets the temperature Tr of the resistor r in the initial state to an appropriate value based on, for example, an outside air temperature sensor (not illustrated). Next, the vehicle control unit 13 starts a timer for measuring a cooling time in order to consider a temperature drop due to natural heat radiation in estimating the temperature of the resistor r (St2).

Next, the vehicle control unit 13 determines whether or not the closing control (OFF→ON) of the relay RL4s is executed based on the control information collected from the relay control unit 11 (St3). When the closing control is executed (Yes in St3), the vehicle control unit 13 adds 1 to the number of times N (St4). When the closing control is not being executed (No in St3), the vehicle control unit 13 does not add the number of times N.

$$Tr = Tr + N \times Δ T \qquad ( 1 )$$

Next, the vehicle control unit 13 estimates the temperature Tr of the resistor r based on the number of times N (St5). For example, the vehicle control unit 13 calculates the temperature Tr according to the above equation (1). In Equation (1), ΔT is the amount of temperature rise due to one closing of the relay RL4s.

Next, the vehicle control unit 13 determines whether or not the timer has expired (St6). The timer expires when a certain time period elapses. If the timer has expired (Yes in St6), the vehicle control unit 13 lowers the temperature Tr by a predetermined value (St7). At this time, the vehicle control unit 13 determines that the temperature of the resistor r has decreased by a certain value due to natural heat dissipation. The amount of decrease in temperature is determined based on, for example, a result of a simulation or an experiment in advance. The vehicle control unit 13 then restarts the timer (St8). When the timer has not expired (No in St6), the processes in St7 and St8 are not executed, and the following process in St9 is executed.

Next, the vehicle control unit 13 compares the temperature Tr with a threshold value th (St9). When Tr<TH is satisfied (Yes in St9), the vehicle control unit 13 determines that the resistor r is not overheated, and switches the mode to the normal mode (St10). In addition, when Tr≥TH is satisfied (No in St9), the vehicle control unit 13 determines that the resistor r is overheated, and switches the mode to the restricted mode (St11). The threshold value TH is determined based on, for example, a result of a simulation or an experiment in advance.

Next, the vehicle control unit 13 determines whether or not to end the operation due to a cause such as power off (St12). When the operation is continued (No in St12), the processing after St3 is executed again. When the operation is ended (Yes in St12), the process is ended.

In this way, the vehicle control unit 13 estimates the temperature Tr of the resistor r based on the number of times N that the relay RL4s is controlled to be closed. The vehicle control unit 13 switches the mode to the normal mode when the temperature Tr is less than the threshold value TH, and switches the mode to the restricted mode when the temperature Tr is equal to or greater than the threshold value TH. Therefore, the vehicle control unit 13 acquires the temperature Tr of the resistor r without requiring a temperature sensor or the like. Alternatively, the vehicle control unit 13 may acquire the temperature Tr from a temperature sensor.

The vehicle control unit 13 lowers the temperature Tr by a predetermined value every time a certain period of time elapses. Therefore, the vehicle control unit 13 estimates the temperature Tr easily and with high accuracy in consideration of natural heat dissipation of the resistor r. Note that, for example, when the vehicle control unit 13 acquires the temperature Tr from the temperature sensor as described above, the vehicle control unit 13 does not need to execute the process of lowering the temperature Tr.

### Precharging Process

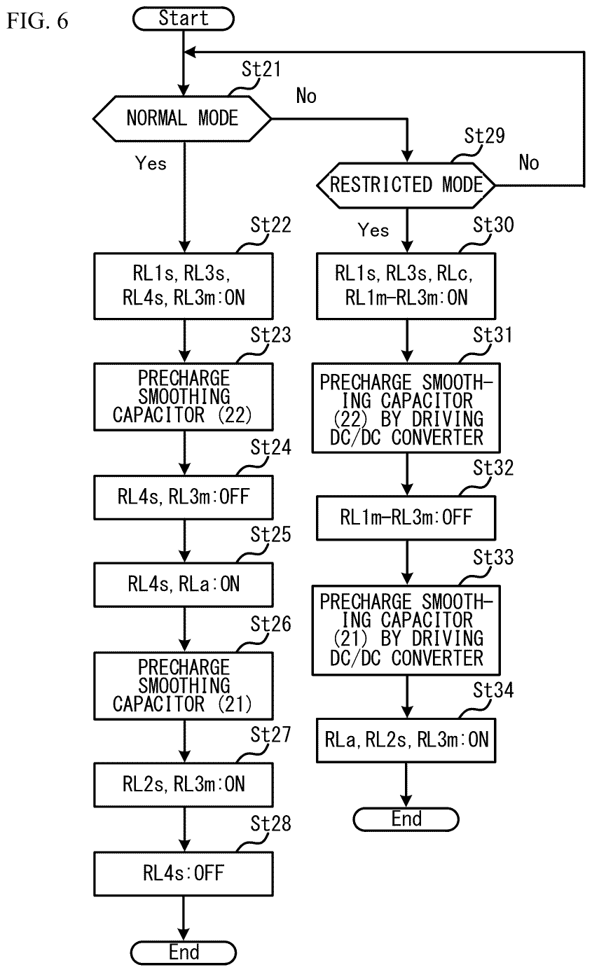

FIG. 6 is a flowchart illustrating the precharging process. This process is executed when the power supply device S is activated. When the mode is the normal mode (Yes in St21), the vehicle control unit 13 executes the following processes in St22 to St28.

First, the relay control unit 11 performs closing control (ON) of the relays RL1s, RL3s, RL4s, and RL3m (St22). Therefore, a current flows between the battery Ed and the smoothing capacitor 22.

Next, the vehicle control unit 13 precharges the smoothing capacitor 22 from the battery Ed (St23). At this time, the vehicle control unit 13 controls the charging period based on the detected voltage of the voltage sensor 24 so that the voltage VL between the both terminals of the smoothing capacitor 22 and the voltage of the battery Ed become substantially equal to each other. The voltage of the battery Ed is acquired from, for example, a voltage sensor (not illustrated) provided in the battery Ed.

Next, the relay control unit 11 controls the relays RL4s and RL3m to be opened (OFF) (St24). Therefore, the current flow between the battery Ed and the smoothing capacitor 22 is interrupted.

Next, the relay control unit 11 controls the relays RL4s and RLa to be closed (St25). Therefore, a current flows between the batteries Eu and Ed and the smoothing capacitor 21.

Next, the vehicle control unit 13 precharges the smoothing capacitor 21 from the batteries Eu and Ed (St26). At this time, the vehicle control unit 13 controls the charging period based on the detected voltage of the voltage sensor 23 so that the voltage VH between the both terminals of the smoothing capacitor 21 and the total voltage of the batteries Eu and Ed become substantially equal to each other. The voltage of the battery Eu is acquired from, for example, a voltage sensor (not illustrated) provided in the battery Eu.

Next, the relay control unit 11 controls the relays RL2s and RL3m to be closed (St27). Therefore, a current flows in the power supply line VDDa and the ground line SG between the batteries Eu and Ed and the inverters 6 and 7, and the power supply device S is activated. Next, the relay control unit 11 controls the relay RL4s to be opened (St28).

In this way, in the normal mode, the smoothing capacitors 21 and 22 are precharged from the power supply PWR, and thus the electric power of the auxiliary battery 84 is not consumed. On the other hand, when the mode is the restricted mode (No in St21, Yes in St29), the vehicle control unit 13 executes the following processing in St30 to St34.

First, the relay control unit 11 performs control to close the relays RL1s, RL3s, RLc, and RL1m to RL3m (St30). Therefore, the smoothing capacitor 22 is connected between the input/output terminals T1c and T1d of the bidirectional DC/DC converter 30, and the auxiliary battery 84 is electrically connected to the smoothing capacitors 21 and 22.

Next, the vehicle control unit 13 causes the converter control unit 12 to perform the switching operation of the bidirectional DC/DC converter 30, thereby precharging the smoothing capacitor 22 from the auxiliary battery 84 (St31). At this time, the vehicle control unit 13 controls the charging period based on the detected voltage of the voltage sensor 24 so that the voltage VL between the both terminals of the smoothing capacitor 22 and the voltage of the battery Ed become substantially equal to each other. Before the smoothing capacitor 22 is precharged, the converter control unit 12 causes the bidirectional DC/DC converter 30 to perform a switching operation, thereby precharging the capacitor 31 of the charging unit 3 from the auxiliary battery 84. At this time, the converter control unit 12 controls the bidirectional DC/DC converter 30 based on the voltage detected by the voltage sensor 32.

In this process, the smoothing capacitor 21 is charged at the same time as the smoothing capacitor 22 is charged. However, as described above, the smoothing capacitor 22 is charged until the voltage VL substantially reaches the voltage of the battery Ed, whereas the smoothing capacitor 21 is charged until the voltage VH substantially reaches the total voltage of the batteries Eu and Ed. Therefore, in this process, only the charging of the smoothing capacitor 22 is completed.

Next, the relay control unit 11 performs control to open the relays RL1m to RL3m (St32). Therefore, the current flowing between the auxiliary battery 84 and the smoothing capacitor 22 is cut off. The current flowing between the auxiliary battery 84 and the smoothing capacitor 21 is maintained.

Next, the vehicle control unit 13 causes the converter control unit 12 to perform the switching operation of the bidirectional DC/DC converter 30, thereby precharging the smoothing capacitor 21 from the auxiliary battery 84 (St33). At this time, the vehicle control unit 13 controls the charging period based on the detected voltage of the voltage sensor 24 so that the voltage VH between the both terminals of the smoothing capacitor 21 and the total voltage of the batteries Eu and Ed become substantially equal to each other.

Next, the relay control unit 11 controls the relays RLa, RL2s, and RL3m to be closed (St34). Therefore, a current flows in the power supply lines VDDa and VDDb and the ground line SG between the batteries Eu and Ed and the inverters 6 and 7, and the power supply device S is activated. When the mode is neither the normal mode nor the restricted mode (No in St29), that is, when the mode is in the unconfirmed state, the vehicle control unit 13 executes the processing after St21 again.

In this way, in the restricted mode, the relay RL4s for precharging is in the open state, but the control unit 1 charges the smoothing capacitors 21 and 22 from the auxiliary battery 84 by the operation of the bidirectional DC/DC converter 30. Therefore, the power supply device U is quickly activated without waiting for the resistor r to be cooled. In the restricted mode, the smoothing capacitors 21 and 22 are precharged from the auxiliary battery 84, and thus the power of the batteries Eu and Ed is saved. In the present embodiment, the above-described precharging method is used for precharging the two smoothing capacitors 21 and 22, but may be used for only one of the smoothing capacitors 21 and 22.

Although some embodiments of the present disclosure have been described in detail, the present disclosure is not limited to the specific embodiments but may be varied or changed within the scope of the present disclosure as claimed.

What is claimed is:

1. A power supply device comprising:
a power supply that supplies power to a motor that drives a vehicle;
a first inverter and a second inverter connected to each other via a winding of each phase of the motor;
a first relay and a second relay respectively interposed in a pair of power lines between both terminals of the power supply and the first inverter and the second inverter;
a capacitor configured to smooth a voltage between the pair of power lines on an input side of the first inverter or the second inverter;
a third relay including an end connected between the second relay and the first inverter;
a resistor including:
an end connected to another end of the third relay; and
another end connected between one of the both terminals of the power supply and the second relay;
a bidirectional DC/DC converter including:
a pair of first input/output terminals connected to the pair of power lines; and
a pair of second input/output terminals connected to both terminals of an auxiliary battery of the vehicle; and
a control unit configured to control the first relay, the second relay, the third relay, and the bidirectional DC/DC converter,
wherein
the control unit is configured to switch a mode of the control unit to a first mode or a second mode in accordance with a temperature of the resistor, closing of the third relay being unrestricted in the first mode and being restricted in the second mode,
the control unit in the first mode is configured to control the first relay and the third relay to be closed to charge the capacitor from the power supply, when the first relay, the second relay, and the third relay are in an open state, and to control the second relay and the third relay to be closed and opened respectively after charging of the capacitor is finished,
the control unit in the second mode is configured to control the first relay to be closed and to control the bidirectional DC/DC converter so as to charge the capacitor from the auxiliary battery, when the first relay, the second relay, and the third relay are in an open state, and to control the second relay to be closed after the charging of the capacitor is finished.

2. The power supply device according to claim 1, wherein
the control unit is configured to estimate the temperature of the resistor based on a number of times the third relay is controlled to be closed, and
the control unit is configured to switch the mode to the first mode when the temperature is less than a threshold value, and to switch the mode to the second mode when the temperature is equal to or greater than the threshold value.

3. The power supply device according to claim 2, wherein the control unit is configured to lower the temperature by a predetermined value every time a certain period of time elapses.
